(19) United States
(12) Patent Application Publication
(10) Pub. No.: US 2022/0270514 A1
(43) Pub. Date: Aug. 25, 2022

(54) PROVIDING TRAINING AND ASSESSMENT OF PHYSIATRICS AND COSMETICS PROCESSES ON A PHYSICAL MODEL HAVING TACTILE SENSORS, USING A VIRTUAL REALITY DEVICE

(71) Applicant: Surreal XRV INC., Calgary (CA)

(72) Inventors: Alpa Mehta, Calgary (CA); Sangeeta Sharma, Calgary (CA)

(21) Appl. No.: 17/677,880

(22) Filed: Feb. 22, 2022

Related U.S. Application Data
(60) Provisional application No. 63/152,802, filed on Feb. 23, 2021.

(51) Int. Cl. G09B 23/30; G09B 5/06; G09B 5/08; G06T 19/00

(52) U.S. Cl. CPC G09B 23/30; G09B 5/06; G09B 5/08; G06T 19/006

(57) ABSTRACT

A method for providing training and assessment of physiatrics based therapy is provided. The method includes (i) performing a specific procedure corresponding to the physiatrics based therapy on an instructor physical model, (ii) communicating a first digital data representing the specific procedure performed on the instructor physical model to an instructor computing device, (iii) communicating the first digital data to an instructor unit comprising the instructor physical model and an instructor virtual reality (VR) device to, (iv) communicating the specific procedure as instructions to a student computing device, (v) performing the specific procedure on a student physical model as per the instructions, (vi) comparing a second digital data with the first digital data for the specific procedure corresponding to the physiatrics based therapy for providing training and assessment of physiatrics based therapy.

### TECHNICAL FIELD

### Background

### Technical Field

The embodiments herein generally relate to providing training and assessment using a physical model and a virtual reality device, and more particularly, to a system and method for providing training, feedback and assessment of performing physiatrics and cosmetics processes on a physical model having sensors, using a virtual reality device.

### Description of the Related Art

Physiatrics based therapy, also known as physiatry, is a branch of medicine that aims to enhance and restore functional ability and quality of life to people with physical impairments or disabilities. Physiatrics based therapy includes, but is not limited to, massage therapy, sports medicine doctors, physiatry, occupational therapists, kinesiologists, athletic therapy and esthetics therapy. As per the current processes, education and training pertaining to physiatrics based therapy is imparted typically by use of classroom teaching and using technology devices that provide video images, audios and corresponding text presentation for the therapy. It is imperative that a student be physically present at the location of such training. In addition, such methodology often lacks objectivity both while imparting the training as well as during evaluating students' skills.

Further, the student explores a website and then books an appointment with an admission advisor to explore various programs. This results in time and resources being spent, even before the education and training start. Further, for practical training purposes, the student will use another student as a body for practice, and in order to provide feedback to the student, the teacher takes feedback from the other student about skill level and mastery of techniques. The input of the other student may not be enough and consistent at all times. In addition, the feedback is subjective in nature as different students share their individual experience based on their personal experiences. Hence, the learning is dependent on the quality and type of feedback which is generally inconsistent between students. A technical problem of providing objective feedback to the student arises. In one existing approach, where such training is offered to the students using internet technologies, there still exists technological challenges related to the trainer having to monitor a number of students at one instance, thereby, lacking fairness and objectivity in evaluating the students' skills. In addition, for the students to get certification from a reputed or good college/university, both physical travel and presence in the class-room setting is a must, which may be really challenging as seen recently during the pandemic situation. Even though most forms of training and assessment may be provided remotely via the internet or virtual reality, there exists a limitation in providing training and assessment of physiatrics based therapy and cosmetics processes, as a body to practice upon is necessary

Accordingly, there arises a need to address the aforementioned technical drawbacks in the existing system and/or technologies in providing training and assessment on performing physiatrics and cosmetics processes.

### SUMMARY

In view of the foregoing, there is provided a method for providing training and assessment of physiatrics and cosmetics processes. The method comprises (i) performing a specific procedure corresponding to the physiatrics based therapy on an instructor physical model, (ii) communicating a first digital data representing the specific procedure performed on the instructor physical model to an instructor computing device, wherein the first digital data represents activation points on the instructor physical model, (iii) communicating the first digital data from the instructor computing device to an instructor unit comprising the instructor physical model and an instructor virtual reality (VR) device to overlay the first digital data on the instructor physical model using the instructor VR device, (iv) communicating the specific procedure from the instructor computing device as instructions through a server to a student computing device, (v) performing the specific procedure on a student physical model as per the instructions, (vi) communicating a second digital data representing the specific procedure performed on the student physical model to the student computing device, wherein the second digital data represents the activation points on the student physical model, (vii) communicating the second digital data from the student computing device to a student unit comprising the student physical model and a student VR device to overlay the second digital data on the student physical model using the student VR device, (viii) communicating the second digital data from the student computing device through the server to the instructor computing device, and (ix) comparing the second digital data with the first digital data for the specific procedure corresponding to the physiatrics based therapy for providing training and assessment of physiatrics based therapy.

Both the first digital data and the second digital data may include (a) a total pressure, (b) a pressure depth, and (c) a spatial sequence of pressure applied on the physical model and (d) temporal sequence of pressure applied on the physical model.

In some embodiments, the instructor computing device is configured to obtain a spatial map of pressure applied at different locations on the instructor physical model, at different points over time corresponding to the activation points on performing the specific procedure, wherein the spatial map is obtained using the first digital data that includes a total amount of pressure applied to a section of the instructor physical model and a depth at which the pressure is applied.

In some embodiments, the instructor computing device is configured to combine the first digital data with an associated virtual environment data to render the combined data on a 3D model of a human body to virtually present the activation points associated with the specific procedure.

In some embodiments, the student computing device is configured to obtain a spatial map of pressure applied at different locations on the student physical model at different points over time corresponding to the activation points on performing the specific procedure, wherein the spatial map is obtained using the second digital data that includes a total amount of pressure applied to a section of the student physical model and a depth at which the pressure is applied.

In some embodiments, the student computing device is configured to combine the second digital data with the associated virtual environment data to render the combined data on the 3D model of the human body to virtually present the activation points associated with the specific procedure.

In some embodiments, the student computing device is configured to capture a temporal sequence associated with the specific procedure and to determine performance values of each of the time-based steps for the student performing the specific procedure.

In some embodiments, the physical model comprises a physical mannequin installed with the physical model of an anatomical structure of the human body.

In some embodiments, feedback is received from the instructor computing device.

In some embodiments, the first digital data and the second digital data comprises an application programming interface (API) data that comprises a student identifier, a timestamp, a procedure identifier, an instructor identifier, a geography identifier for headers, streams of location identifiers, depth and a data stream comprising a quantum of pressure values.

In some embodiments, the physical model mimics conditions of the human body for training the student in the physical model for feeling the conditions and for providing virtual feedback.

In some embodiments, a virtual environment is provided for multiple students and instructors to simulate a classroom environment, or a hospital environment.

In another aspect, there is provided a system for providing training and assessment of physiatrics based therapy, wherein the system comprising: (a) an instructor physical model, wherein a specific procedure corresponding to the physiatrics based therapy is performed on the instructor physical model, (b) an instructor computing device configured to receive a first digital data representing the specific procedure performed on the instructor physical model, wherein the first digital data represents activation points on the instructor physical model, (c) an instructor unit configured to receive the first digital data from the instructor computing device, wherein the instructor unit comprises the instructor physical model and an instructor virtual reality (VR) device, wherein the instructor computing device is communicatively connected to the instructor unit, (d) a student computing device configured to receive the specific procedure from the instructor computing device as instructions, wherein the student computing device is communicatively connected to the instructor computing device, (e) a student physical model, wherein the specific procedure is performed on the student physical model as per the instructions, wherein the student computing device is configured to receive a second digital data representing the specific procedure performed on the student physical model, wherein the second digital data represents the activation points on the student physical model, (f) a student unit comprising the student physical model and a student VR device, wherein the student unit receives the second digital data from the student computing device, wherein the student computing device is communicatively connected to the student unit, wherein the student computing device communicates the second digital data to the instructor computing device, and (g) a server that is configured to (i) overlay the first digital data on the instructor physical model using the instructor VR device, (ii) overlay the second digital data on the student physical model using the student VR device, and (iii) compare the second digital data with the first digital data for the specific procedure corresponding to the physiatrics based therapy for providing training and assessment of physiatrics based therapy.

In some embodiments, the server performs operations comprising updating, deleting, adding, retrieving data representing instructions on receiving a corresponding request from the instructor computing device.

In some embodiments, the instructor computing device is configured to obtain a spatial map of pressure applied at different locations on the instructor physical model, at different points over time corresponding to the activation points on performing the specific procedure, wherein the spatial map is obtained using the first digital data that includes a total amount of pressure applied to a section of the instructor physical model and a depth at which the pressure is applied.

In some embodiments, the instructor computing device is configured to combine the first digital data with an associated virtual environment data to render the combined data on a 3D model of a human body to virtually present the activation points associated with the specific procedure.

In some embodiments, the student computing device is configured to obtain a spatial map of pressure applied at different locations on the student physical model at different points over time corresponding to the activation points on performing the specific procedure, wherein the spatial map is obtained using the second digital data that includes a total amount of pressure applied to a section of the student physical model and a depth at which the pressure is applied.

In some embodiments, the student computing device is configured to combine the second digital data with the associated virtual environment data to render the combined data on the 3D model of the human body to virtually present the activation points associated with the specific procedure.

In another aspect, there is provided a non-transitory computer-readable storage medium storing a sequence of instructions, which when executed by a processor, causes training and assessment of physiatrics based therapy, the sequence of instructions comprising: (i) performing a specific procedure corresponding to the physiatrics based therapy on an instructor physical model, (ii) communicating a first digital data representing the specific procedure performed on the instructor physical model to an instructor computing device, wherein the first digital data represents activation points on the instructor physical model, (iii) communicating the first digital data from the instructor computing device to an instructor unit comprising the instructor physical model and an instructor virtual reality (VR) device to overlay the first digital data on the instructor physical model using the instructor VR device, (iv) communicating the specific procedure from the instructor computing device as instructions through a server to a student computing device, (v) performing the specific procedure on a student physical model as per the instructions, (vi) communicating a second digital data representing the specific procedure performed on the student physical model to the student computing device, wherein the second digital data represents the activation points on the student physical model, (vii) communicating the second digital data from the student computing device to a student unit comprising the student physical model and a student VR device to overlay the second digital data on the student physical model using the student VR device, (viii) communicating the second digital data from the student computing device through the server to the instructor computing device, and (ix) comparing the second digital data with the first digital data for the specific procedure corresponding to the physiatrics based therapy for providing training and assessment of physiatrics based therapy.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a block diagram of a system for providing training and assessment on performing a procedure on a physical model having sensors, using a virtual reality device in accordance with an implementation of the disclosure;

FIGS. 2A-2B are flow diagrams that illustrate a method for providing training and assessment of physiatrics based therapy using a physical system, in accordance with an implementation of the disclosure;

FIG. 3 is a flow diagram that illustrates a method for a physical model of the system of FIG. 1 in accordance with an implementation of the disclosure;

FIG. 4A is a block diagram illustrating various elements of instructor computing device and student computing device of FIG. 1 in accordance with an implementation of the disclosure;

FIG. 4B is a block diagram of the server system of FIG. 1 in accordance with an implementation of the disclosure;

FIG. 5 is an interaction diagram of a method for a student physical model of FIG. 1 operable to conduct a procedure in accordance with an implementation of the disclosure;

FIG. 6A-6F together illustrates sensor arrangements in an exemplary implementation of the physical model in accordance with the disclosure;

FIG. 6G illustrates simulating a physical condition in the physical model in accordance with implementations of the disclosure;

FIG. 6H illustrates an exemplary view of digital data overlay on an exemplary physical model in accordance with the disclosure;

FIGS. 7A-7B illustrate the physical model arranged to provide training and assessment of body in accordance with the disclosure;

FIG. 8 illustrates the physical model arranged to provide training and assessment of cosmetics processes in accordance with the disclosure;

FIG. 9 illustrates the physical model arranged to provide training and assessment of eyelash extensions in accordance with the disclosure;

FIG. 10 illustrates the physical model arranged to provide training and assessment of permanent eyebrows in accordance with the disclosure; and

FIG. 11 is an illustration of a computing arrangement that is used in accordance with implementations of the disclosure.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

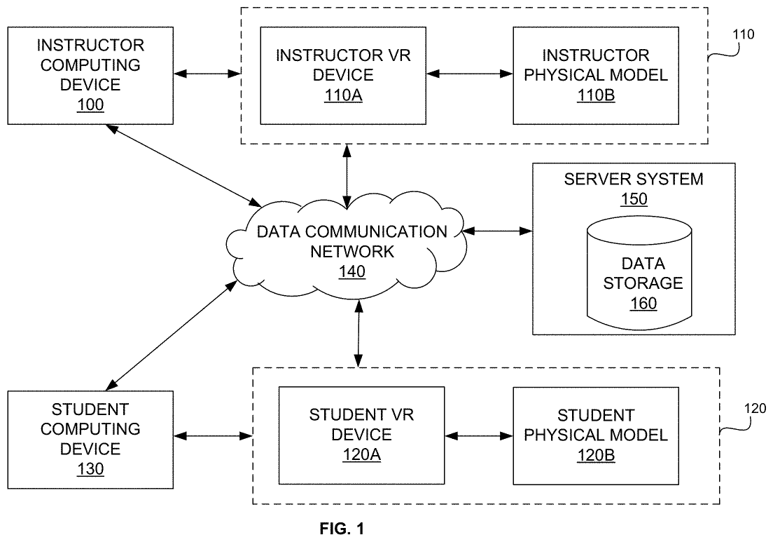

As mentioned, there remains a need to address drawbacks in existing system and/or technologies in providing training and assessment on performing physiatrics based therapy. Referring now to the drawings, and more particularly to FIGS. 1 to 11, where similar reference characters denote corresponding features consistently throughout the figures, preferred embodiments are shown.

FIG. 1 is a block diagram of a system for providing training and assessment on performing a procedure on a physical model having sensors, using a virtual reality device in accordance with an implementation of the disclosure. The system includes an instructor computing device 100, an instructor system 110 shown comprising an instructor VR device 110A, an instructor physical model 110B, student computing device 130, a student system 120 shown comprising a student VR device 120A and a student physical model 120B, a data communication network 140, a server system 150 comprising a data storage 160.

The instructor computing device 100 interfaces with the instructor system 110 while creating instructions for conducting a corresponding procedure. The instructor computing device 100 receives from the instructor physical model 110B digital data representing the corresponding procedure to overlay on the instructor physical model 110B using the instructor VR device 110A. Further, the instructor computing system 100 interacts with the server system 150 to access a corresponding digital data representing instructions stored in the data storage 160 associated with the corresponding procedure. Furthermore, the instructor computing system 100 interacts in real-time with the student computing system 130 in the data communication network 140 to enable a student to view in real-time, instructions and a corrective feedback related to conducting the corresponding procedure.

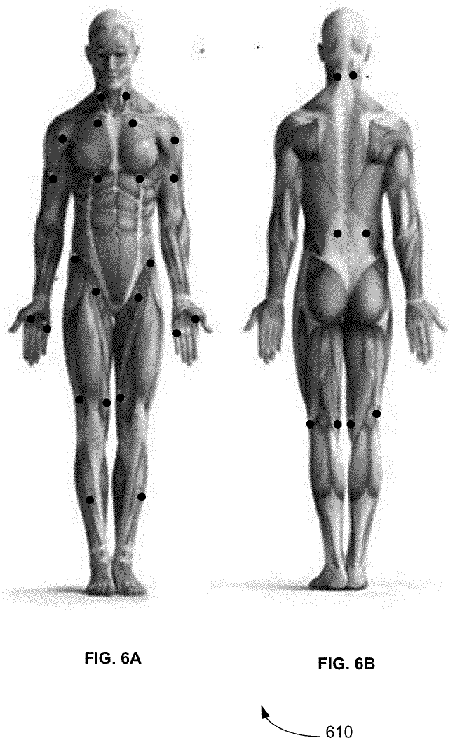

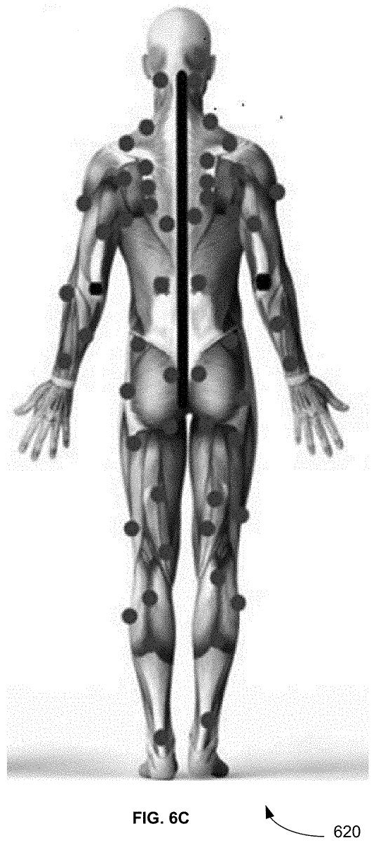

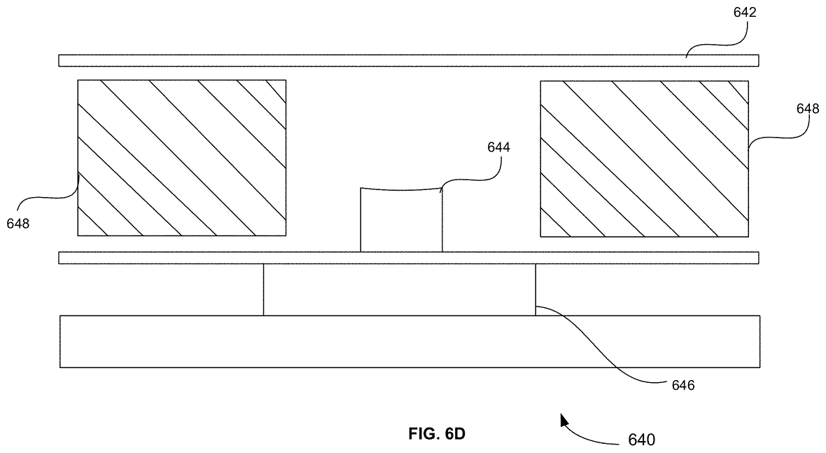

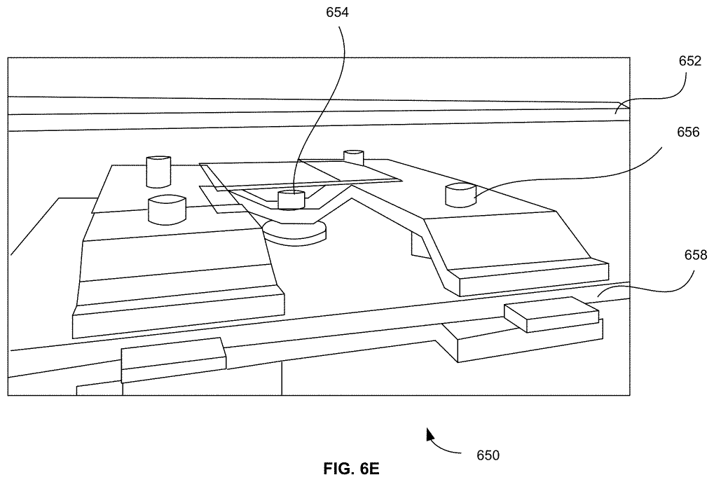

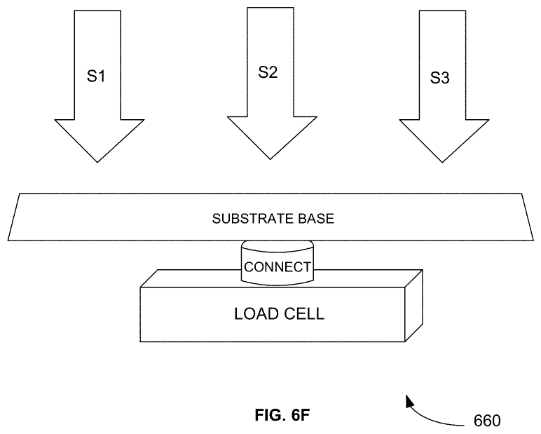

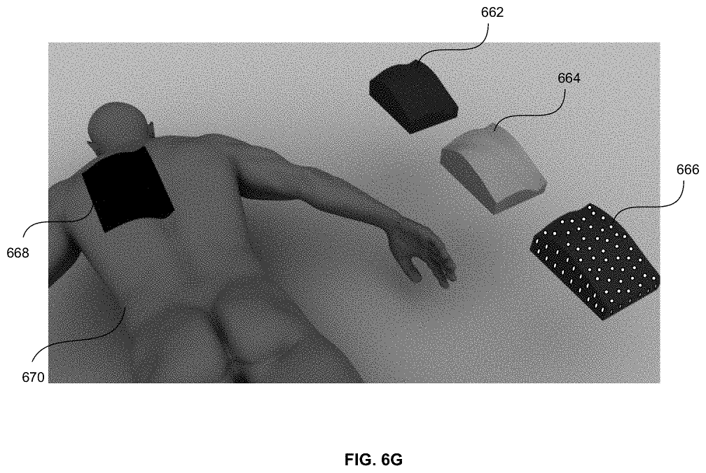

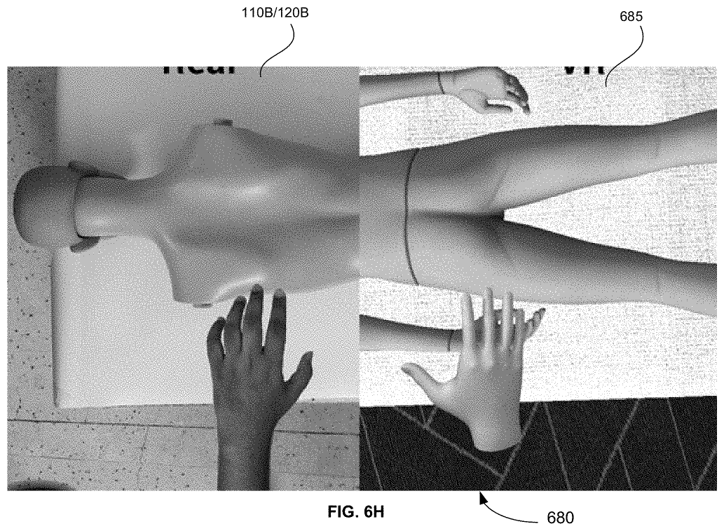

Each of the instructor physical model 110B and the student physical model 120B represents a structure on which an instructor and the student may conduct the corresponding procedure. The instructor physical model 110B and the student physical model 120B communicates (using a Wi-Fi network or any internet service) respectively with the instructor computing device 100 and the student computing device 130 through the server system 150, digital data representing the corresponding procedure conducted on a corresponding physical model. The manner in which the instructor physical model 110B and the student physical model 120B may generate such digital data is described in detail below with respect to illustration of FIG. 6A through FIG. 6H.

The digital data obtained from both the instructor physical model 110B and the student physical model 120B may include (a) a total pressure, (b) a pressure depth, and (c) a spatial sequence of pressure applied on the physical model and (d) temporal sequence of pressure applied on the physical model.

The student computing device 130 interfaces with the student system 120 to enable the student to conduct the corresponding procedure. The student computing device 130 receives from the student physical model 120B digital data representing the corresponding procedure to overlay on the student physical model 120B using the student VR device 110A. Further, the student computing system 130 interacts with the server system 150 to access digital data representing instructions associated with the corresponding procedure stored in the data storage 160. Furthermore, the student computing system 130 interacts in real-time with the instructor computing system 100 in the data communication network 140 to enable the student to view in real-time instructions, the corrective feedback in conducting the corresponding procedure.

Each of the instructor VR device 110A and the student VR device 120A represents a corresponding device (such as a VR headset) that can simulate a virtual environment in which to conduct the procedure. Accordingly, the instructor VR device 110A and the student VR device 120A overlays the digital data representing conduction of the procedure, feedback on the procedure on the instructor physical model 110B and the student physical model 120B respectively.

The data communication network 140 provides connectivity between the instructor computing device 100, the instructor system 110, the student system 120, the student computing device 130, and the server system 150. The data communication network 140 may be a wireless network, a wired network, a combination of a wired network or a wireless network, or the Internet. The data storage 106 communicates interactively and stores data received in the data communication network 140.

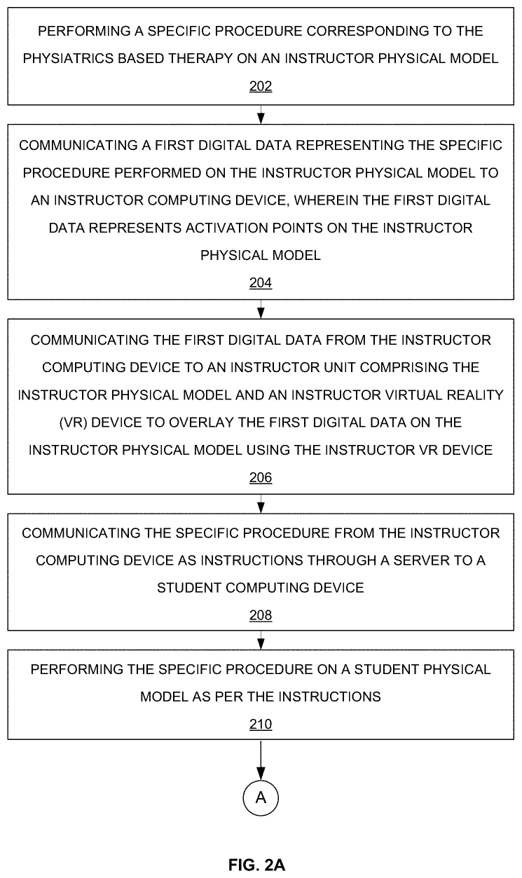

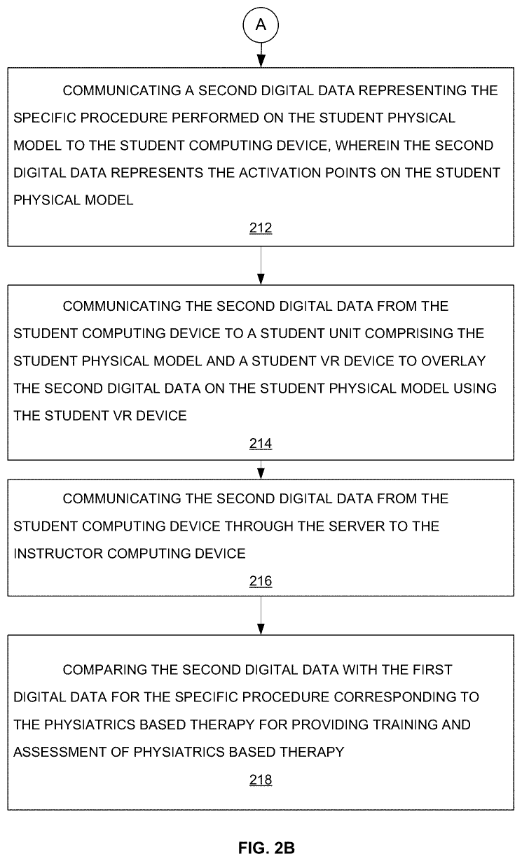

FIGS. 2A-2B are flow diagrams that illustrate a method for providing a physical model for training and assessment of physiatrics based therapy, in accordance with an implementation of the disclosure. At step 202, a specific procedure is performed corresponding to the physiatrics based therapy on an instructor physical model. At step 204, a first digital data is communicated representing the specific procedure performed on the instructor physical model to an instructor computing device, wherein the first digital data represents activation points on the instructor physical model. At step 206, the first digital data is communicated from the instructor computing device to an instructor unit comprising the instructor physical model and an instructor virtual reality (VR) device to overlay the first digital data on the instructor physical model using the instructor VR device. At step 208, the specific procedure is communicated from the instructor computing device as instructions through a server to a student computing device. At step 210, the specific procedure is performed on a student physical model as per the instructions. At step 212, a second digital data representing the specific procedure performed on the student physical model is communicated to the student computing device, wherein the second digital data represents the activation points on the student physical model. At step 214, the second digital data is communicated from the student computing device to a student unit comprising the student physical model and a student VR device to overlay the second digital data on the student physical model using the student VR device. At step 216, the second digital data is communicated from the student computing device through the server to the instructor computing device. At step 218, the second digital data is compared with the first digital data for the specific procedure corresponding to the physiatrics based therapy for providing training and assessment of physiatrics based therapy.

In some embodiments, the instructor computing device is configured to obtain a spatial map of pressure applied at different locations on the instructor physical model, at different points over time corresponding to the activation points on performing the specific procedure, wherein the spatial map is obtained using the first digital data that includes a total amount of pressure applied to a section of the instructor physical model and a depth at which the pressure is applied.

In some embodiments, the instructor computing device is configured to combine the first digital data with an associated virtual environment data to render the combined data on a 3D model of a human body to virtually present the activation points associated with the specific procedure.

In some embodiments, the student computing device is configured to obtain a spatial map of pressure applied at different locations on the student physical model at different points over time corresponding to the activation points on performing the specific procedure, wherein the spatial map is obtained using the second digital data that includes a total amount of pressure applied to a section of the student physical model and a depth at which the pressure is applied.

In some embodiments, the student computing device is configured to combine the second digital data with the associated virtual environment data to render the combined data on the 3D model of the human body to virtually present the activation points associated with the specific procedure.

In some embodiments, the student computing device is configured to capture a temporal sequence associated with the specific procedure and to determine performance values of each of the time-based steps for the student performing the specific procedure.

In some embodiments, the physical model comprises a physical mannequin installed with the physical model of an anatomical structure of the human body.

In some embodiments, feedback is received from the instructor computing device.

In some embodiments, the first digital data and the second digital data comprises an application programming interface (API) data that comprises a student identifier, a timestamp, a procedure identifier, an instructor identifier, a geography identifier for headers, streams of location identifiers, depth and a data stream comprising a quantum of pressure values.

In some embodiments, the physical model mimics conditions of the human body for training the student in the physical model for feeling the conditions and for providing virtual feedback.

In some embodiments, a virtual environment is provided for multiple students and instructors to simulate a classroom environment, or a hospital environment.

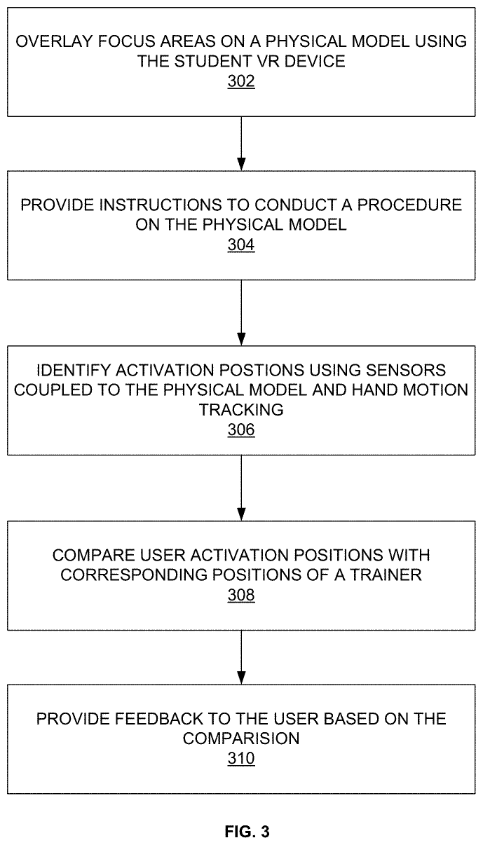

FIG. 3 is a flow diagram that illustrates a method for the student computing device 130 to receive instructions, feedback while conducting the corresponding procedure in accordance with an implementation of the disclosure. At step 302, the student computing device overlays focus areas on the physical model using the student VR device. A manner in which such overlaying is performed on the physical model based on mixed reality is illustrated in detail with respect to the description of FIG. 6H. At step 304, instructions to conduct the procedure on the physical model are provided. At step 306, the activation positions are identified using the sensors coupled to the physical model and hand motion tracking. At step 308, the user activation positions are compared with corresponding positions of the instructor. At step 310, feedback is provided to the student based on the comparison of the user activation positions with corresponding positions of the instructor.

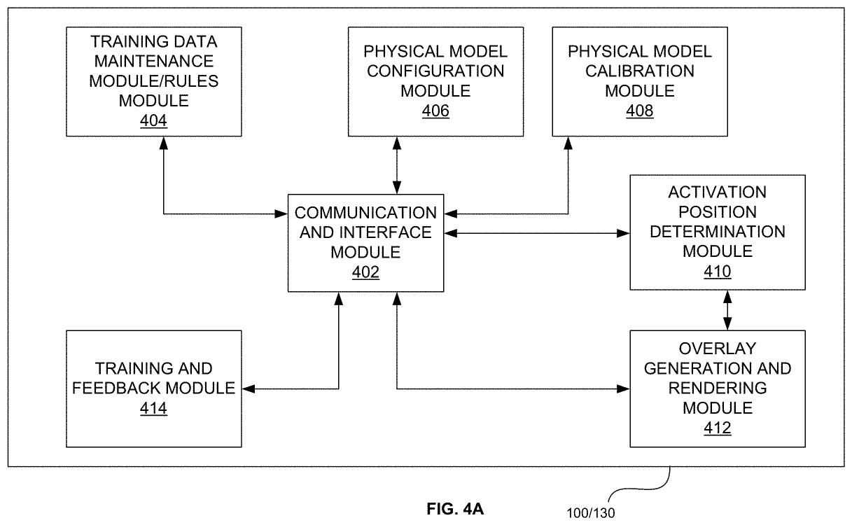

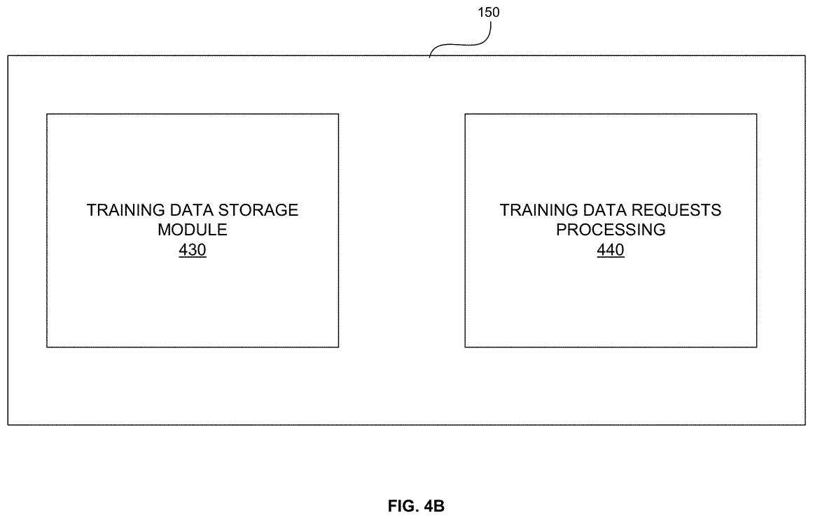

FIG. 4A is a block diagram of the instructor computing device 100 and the student computing device 130 in accordance with an implementation of the disclosure. As described above with respect to illustration of various elements of the block diagram of FIG. 1, the instructor computing device 100 is operable in conjunction with the instructor system 110 and the student computing device 130 is operable in conjunction with the student system 120 in implementing several aspects of the disclosure as described in detail below.

The block diagram of FIG. 4A is shown including the following modules: i) a communication and interface module 402, ii) a training data maintenance module 404, iii) a physical model configuration module 406, iv) a physical model calibration module 408, v) an activation position determination module 410, vi) an overlay generation and rendering module 412, and vii) a training and feedback module 414.

In the instructor computing device 130, the communication and interface module 402 enables data communication between the instructor computing device 100 and the instructor system 110. In the instructor computing device 100, the communication and interface module 402 enables digital data representing the corresponding procedure to be received at the instructor computing device 100, when the instructor conducts the procedure on the instructor physical model 110A. The instructor computing device 100 further communicates on the communication and interface module 402, the digital data representing the corresponding procedure to overlay on the instructor physical model 110B using the instructor VR device 110A.

In the student computing device 130, the communication and interface module 402 enables communication between the student computing device 130 and the student system 120. Accordingly, the student computing device 130 overlays (step 202) focus areas (by communicating corresponding digital data representing the corresponding procedure the student is conducting on the student physical model 120B) on the student physical model 120B using the student VR device 120A. The digital data may include an application programming interface (API) data. The API data may include a student identifier, a timestamp, a procedure identifier, an instructor identifier, a geography identifier for headers that may be followed by streams of location identifiers, depth and a data stream including a quantum of pressure values.

In an embodiment as described in detail below with respect to the description of FIG. 6A-6H, digital data indicating an activation of the sensor switch comprised in the student physical model 120B and the instructor physical model 110B communicated in the communication and interface module 402 to the student computing device 130 and the instructor computing device 110 respectively generate the overlay on the student physical model and the instructor physical model using the corresponding student VR device and the instructor VR device. (130A and 110A).

The training data maintenance module/Rules module 404 is operable to generate, update (maintain) and store (in the data storage 160) digital data indicating instructions for the procedures conducted. In addition, the training data maintenance module/Rule module 404 is operable to provide (as in step 204) instructions to conduct the procedure to the student computing device 130 on the data communication network 140, on receiving a corresponding request from the student computing device 130.

The physical model configuration module 406 enables the student (or the instructor) to get the physical feel of the corresponding condition by correlating the digital view (VR view) overlaying on the corresponding physical model for the student to conduct a corresponding applicable procedure (for the specific condition) on the physical model based on the digital view.

In an alternative embodiment, props such as marble like objects, strings/ropes/springs etc. can be used to simulate the body of the subject with various physical conditions.

The physical model calibration module 408 enables values associated with various parameters for the corresponding physical model (110B/120B) to be modified/set. According to an aspect of the disclosure, the physical model is calibrated so that corresponding values of tension, rotation limitation, rigidity, flexibility, range of motion can be suitable set/altered to correspond to the physical condition.

In an alternative embodiment, the physical model calibration module 408 may comprise the physical condition simulator that can be used to replace a part of the physical model for the corresponding physical condition. Further, corresponding digital data may be used to overlay on the corresponding physical model (110B/120B) in order for the student to visualize changes in the physical parts of the physical model for the corresponding physical condition.

In yet another alternative embodiment, the physical model calibration module 408 comprises a setting adjuster to adjust a range of motion of various joints for a corresponding severity of the physical condition (for example, arthritis).

The table below illustrates example health condition, digital data for the student VR device 120A/instructor VR device 110A to overlay on the physical model for specific physical conditions/severity of the physical condition.

| Condition | Simulation Props |
|---|---|
| Tumor | Marbles under synthetic skin |
| Arthritis | Motion limiter (with ropes) |
| Trigger Points | Tight Band Like feel in muscle with sensitive points |
| Adhesion | small marble like hard thick feeling on muscle, like |
| | tissue is stuck together which is less mobile. |
| muscular atrophy | week, soft and little resilience comparatively small |
| | muscle |
| swelling | baggy and congested area |
| limited ROM | muscle spasm, early hard/capsular end feel, tissue |
| | stretch, empty |
| tender point | localised sensitive points |
| referred pain | sensitive point with referring pain in distance area |
| crepitus | palpable roughness in the joint or tendon that is |
| | noted with movement and sometimes accompanied |
| | by audible crunching. |
| in Jaw | Hypertonicity, trigger points and tenderness due to |
| | ischemia may be palpated in a variety of muscles. |
| | The muscles of mastication are affected by jaw |
| | clenching. Apical breathing contributes to |
| | hypertonicity and TPs in the neck and shoulder |
| | muscles. Low back muscles may be tight from |
| | holding the body rigidly, popping or clicking, jaw |
| | deviation |
| Strain | thick, fibrous, possible adhesions and or palpable gap |
| | (tissue progressively less firm |
| Cruciate Injury— | Texture: adhesions in quads, gastrocnemius, |
| Cruciate: | hamstrings, boggy edema around knee. |
| Meniscal Injury | adhesions in quads, gastrocnemius, hamstrings, |
| | boggy edema around knee |
| Whiplash | firm edema (acute), adhesions (sub-acute/chronic) |
| Plantar Fasciitis | thickening, adhesions tender to touch,(anterior/medial |
| | aspect affected plantar fascia) |
| Tendinitis | swelling at tendon (acute), adhesions granular |
| | (chronic) |
| Frozen Shoulder | fibrosing /disuse atrophy in rotator cuff muscles (sub- |
| | acute) |
| Torticollis | Text: ropy (upper/middle traps) scalenes, |
| | sternocleidomastoid, levator scapula, rhomboids |
| | (bilateral) |
| Pes Planus | thick near talus |
| Iliotibial Band | ITB (affected side) thickened, with possible |
| Contracture (ITB | adhesions |
| contracture) | |
| Hyperlordosis | thickened /reinforced Iliotibial band and lumbar |
| Scoliosis | fascia fibrosing on the concave side. |
| Hyperkyphosis | thickened pectoral fascia |
| TMJD | edema, fibrosing/adhesions (MOM). |
| Carpal Tunnel | boggy edema at carpal tunnel w/ adhesions at flexor |
| Syndrome | retinaculum, atrophy at thenar (in later stages) |

The activation position determination module 410 receives digital data for the corresponding procedure conducted. In an embodiment as described below in detail with respect to FIG. 6A-6H, the activation position determination module 410 captures information and estimates pressure values on a user conducting the procedure and corresponding activation positions. An example estimation is described in detail below with respect to the illustration of FIGS. 6A-6H.

In another alternative embodiment, the activation position determination module 410 during the conduction of the procedure captures tracking of hand movements (by comprising corresponding devices such as tactile sensors, mono/stereoscopic camera tracking or gyro system).

The overlay generation and rendering module 412 overlays digital information on the physical model using the corresponding VR device (110A/120A). The overlay generation and rendering module 412 receives digital data for the corresponding procedure conducted on the physical model and combines with data from the data storage 160 of an associated virtual environment to render the combined data (of the overlay) on a 3D model of a human body to virtually show the user/student/instructor the activation points associated with conducting the procedure in detail. An example VR device rendering overlay information on the physical model is described in detail below with respect to illustration of FIG. 6H.

In an embodiment, the overlay generation and rendering module 412 may perform calibration of the VR device (110A/120A) with the physical model using one or more markers on the physical model. The markers may include a quick response (QR) code, a barcode, or a coloured marker. Optionally, the overlay generation and rendering module 412 may perform calibration of the VR device (110A/120A) with the physical model using a physical alignment jig or a cradle, where the VR device (110A/120A) may be placed on the surface and calibrated for zero referencing.

The training and feedback module 414 computes a corrective feedback on the procedure conducted by the user/student. According to an aspect of the disclosure, the training and feedback module 414 provides the corrective feedback on the procedure instantaneously to the user/student, using the corresponding VR device (110A/120A), on the physical model used for conducting the procedure.

In an embodiment, the training and feedback module 414 evaluates the student's skill in conducting the procedure by capturing in a temporal map, a sequence associated with the procedure, determining performance values of each of the time-based steps for both the instructor and the student performing the procedure and computing a weighted average. Evaluation of the student's skill may be performed by comparing a first digital data obtained from the instructor physical model 110B with a second digital data obtained from the student physical model 120B for the specific procedure corresponding to the physiatrics based therapy for providing training and assessment of physiatrics based therapy. The first digital data and second digital data may include (a) a total pressure, (b) a pressure depth, and (c) a spatial sequence of pressure applied on the physical model and (d) temporal sequence of pressure applied on the physical model.

Assuming that the temporal map for the procedure as noted below,

| Time | Trigger Point - Sensor ID | | Intensity Value | Level |
|---|---|---|---|---|
| Sec - 1 | Lower Back 1 - | 12124 | Value 4 | Superficial |
| Sec - 2 | Middle Back 2 - | 12474 | Value 7 | Deep |
| Sec - 3 | Middle back 3 - | 18323 | Value 2 | Superficial |
| Sec - 4 | Upper Back - | 13429 | Value 7 | Superficial |

Sequence of activation—A (Normalised)

Level of triggering—L (Normalised)

Intensity—I (Normalised)

Speed—S (Normalised)

The training and feedback module 314 computes the weighted average for grading which is computed using the equation

Total Grade=WA×A+WL×L+WI×I+WS×S

In an embodiment, the training and feedback module 314 may show either in a mixed-reality environment or in real-time, the corrective feedback on the procedure conducted by the student in 3D on the same physical model in a virtual environment. The hand motion tracking may be performed by visual tracking based on machine learning techniques. A tactile sensor array or hand motion tracking based on a glove may be used with the machine learning techniques to give accurate procedure conduction to the student. Additional embodiments illustrating the specific procedure in performance of the student conducting the procedure are evaluated for the specific physical condition of the subject and are listed in Annexure A.

FIG. 4B is a block diagram illustrating the server system in accordance with the implementation of the disclosure. The server system 150 of FIG. 4B is accordingly shown comprising the training data storage module 430 and the training data requests processing module 440.

The training data storage module 430 receives (from the instructor computing device 100) on the data communication network 140 data indicating instructions for the corresponding procedure on the instructor physical model 110B and stores the instructions in the data storage 160.

The training data requests processing module 440 enables the server system 150 to process requests to perform the corresponding operations on data representing instructions. For example, the training data requests processing module 440 may execute instructions on the server system 160 to perform operations including update, delete, add, retrieve data representing instructions in the data storage 160, when on receiving a corresponding request from the instructor computing device 100.

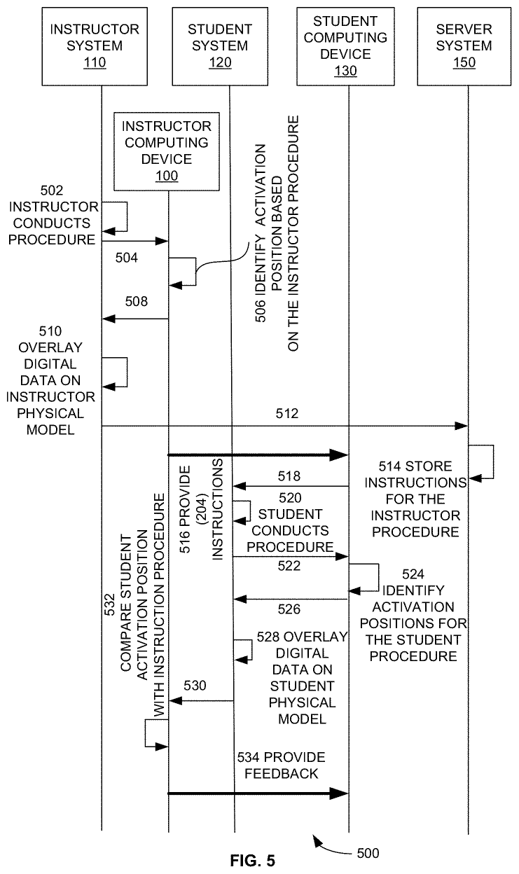

FIG. 5 is an interaction diagram of a method for the student computing device 130 receiving instantaneous feedback on the procedure from the instructor computing device 100 of FIG. 1 in accordance with an implementation of the disclosure. At step 502, the instructor system 110 enables the instructor to conduct the procedure. During the step, the instructor system 110 may enable the instructor to perform necessary calibrations based on the specific condition associated (with the subject) for conducting the procedure. Subsequently, the instructor may proceed to conduct the procedure on the instructor physical model. At step 504, digital data representing the procedure is sent to the instructor computing device 100. At step 506, instructor computing device 100 identifies activation positions based on the conducted procedure. At step 508, the instructor computing device 100 communicates the digital data to the instructor system 110 for the instructor system 110. At step 510 to provide an overlay of the digital data on the instructor physical model 120B using the instructor VR device 120A. At step 512, the instructor computing device 100 sends digital data (comprising the instructions) for the procedure to the server system 150 which in turn at step 514 stores the instructions in the data storage 160. At step 516, the instructor computing device 100 provides the instructions to the student computing device 130 (on the data communication network 140). At step 518, the student computing device 130 (using a Wi-Fi 33 connectivity) sends the provided digital data representing the instructions to overlay on the student physical model 120B.

At step 520, the student conducts the procedure on the student physical model 120B (as per instructions) and at step 522, the student system 120 sends digital data representing the conducted procedure to the student computing device 130 for identifying the activation positions based on the student procedure at step 524. At step 526, the student system 120 receives the activation positions and at step 528, overlays the digital data representing the activation positions on the student physical model 120B using the student VR device 120A.

At step 530, digital data representing the activation positions on the student physical model 120B is sent to the instructor computing device 100. At step 532, the instructor computing device 100 compares the digital data representing the activation positions due to the student conducting the procedure with that comprised on instructions provided at step 516 and provides the feedback instantaneously and grades the student's skill on conducting the procedure.

FIG. 6A through FIG. 6F together represent an arrangement of the array of sensors in the instructor physical model 110B and the student physical model 120B in an embodiment of the disclosure.

FIG. 6A through FIG. 6C indicates the positioning of the sensors in the physical model (110B/120B) in an embodiment of the disclosure. The dots in FIG. 6A and FIG. 6B indicates that the sensors are at a superficial layer close to the surface of the physical model while the blue dots in FIG. 6C indicates that the sensors are deep down the surface of the physical model. Different levels for the sensor reflect and teach both the Depth and the Quantum of pressure to apply while conducting the specific procedure. The depth and the quantum of pressure may be generated either through both the activation position or a reading obtained from the pressure sensors. In some embodiments, the physical model has one or more than one pressure sensor. The pressure sensor includes multiple tactile switches. The number of pressure sensors in the physical model may be increased but they are less than the number of tactile switches. The depth at which the pressure sensor is triggered enables determining whether the applied pressure is a deep pressure or a superficial pressure.

FIG. 6D indicates the sensor used in the physical model in an embodiment of the disclosure. A limit switch (644) is triggered when the user touches in the area above a synthetic skin layer (642). The limit switch (644) triggers a sensor pad (646) below and the amount of pressure is accordingly captured. The deeper touches are sensed by the second sensor unit (see FIG. 6E) which is placed deeper in the synthetic skin layer (642). Between the synthetic skin layer (642) and the sensor pad (646), there is a sponge (646). The sponge (646) may a polyurethane foam. The sponge (646) provides support to the synthetic skin layer (642) and helps in retaining shape of the physical model after pressure is applied on the activation point. In some embodiments, the limit switch may be a tactile switch.

FIG. 6E indicates an arrangement of the array of sensors in the physical model in an embodiment of the disclosure. The arrangement is shown comprising of a synthetic skin (652) of the physical model, a top level sensor (654), a deep level sensor (656) and a hard base substrate (658). Such an arrangement of the array of sensor creates the temporal array of pressures at different points over time. The motion of the student's conduction and pressure values are estimated based on the array of pressures, and further used to analyse performance and accuracy of the student's conducting the procedure.

FIG. 6F illustrates elements in the arrangement of the array of sensors involved in computation of the total weight/pressure applied on the physical model (110B/120B) while conducting the corresponding procedure on the physical model, in an embodiment of the disclosure.

The weight being applied is captured using 2 methods—a) the Piezoelectric unit in the sensing layer below the switch by detecting the switch which is triggered and reading the piezoelectric cell value and converting to a load value. b) the load Cell unit in the base.

In the arrangement of FIG. 6E, multiple load cells are shown as spread across the different areas of the physical model. By capturing the total load in a particular area of the device and detecting the switches which are triggered, it is possible to estimate the area being triggered during conduction of the procedure and the load applied to trigger.
Pressure at a point n is computed based on the formula below:

Pn=Sn×Ptotal
Where Sn is the status of the switch at point n and Ptotal is the total pressure read by the load sensor.

FIG. 6G illustrates simulating the physical condition in the physical model in accordance with implementations of the disclosure. A physical model 670 includes a cavity 668 that may be installed with a first part 662, a second part 664 or a third part 666. The physical model 670 may be calibrated to simulate a first physical condition by a first part 662 that may be associated with the first physical condition. The physical model calibration module 408, which may include the physical condition simulator, may be used to replace a part of the physical model 670 for a corresponding physical condition associated with the first part 662, the second part 664 or the third part 666. Further, corresponding digital data may be overlaid on the physical model 670 in order for the student to visualize changes in the physical parts of the physical model for the corresponding physical condition.

FIG. 6H illustrates an exemplary view of digital data overlay on a physical model in accordance with the disclosure. Accordingly, a portion 680 is shown comprising of the portion 110B/120B with a mannequin as the physical model and a portion 685 with an image of corresponding digital data overlay on the physical model. As described in detail above with illustration of FIG. 3, the overlay generation and rendering module 312 overlays digital information (corresponding to image in portion 685) on the physical model (in portion 110B/120B) using the corresponding VR device (110A/120A) for display.

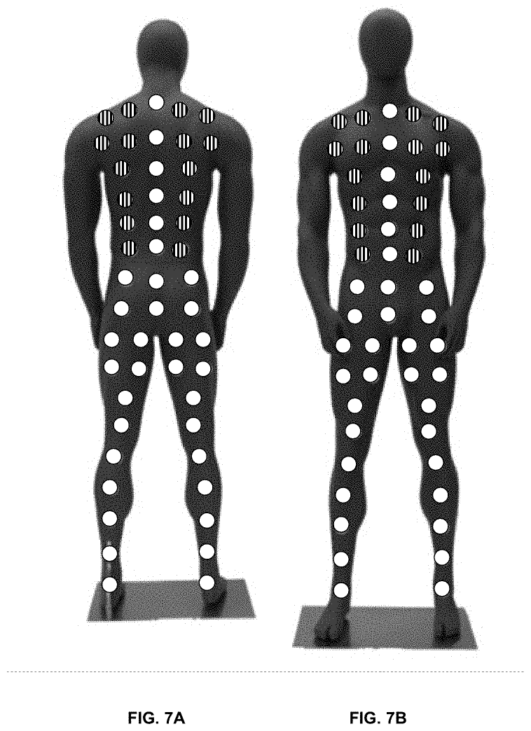

FIGS. 7A-7B illustrate the physical model arranged to provide training and assessment of body in accordance with the disclosure. Physiatrics based therapy includes the science of movement, where internal and external pressures are used via exercise and resistance training to improve mobility of the human body. The method utilizes the physical model and VR for training the student while reducing tuition cost required for the student for traditionally obtaining training and assessment of body. The physical model is used to teach superficial and deep pressure with each exercise and massage by measuring parameters like conditions, flow, pressure and positions of pressure.

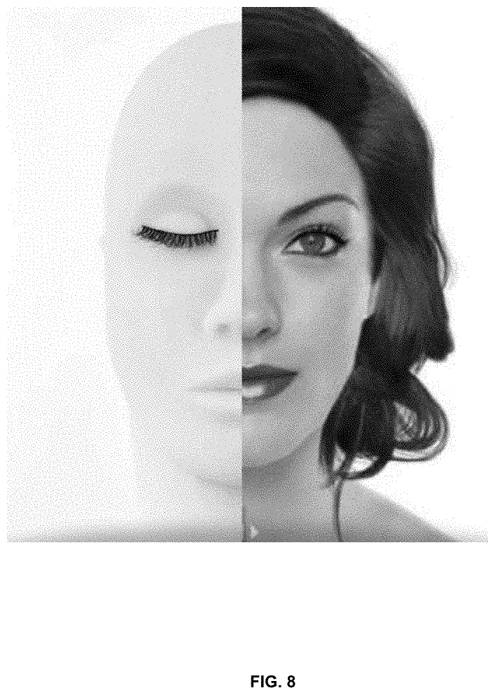

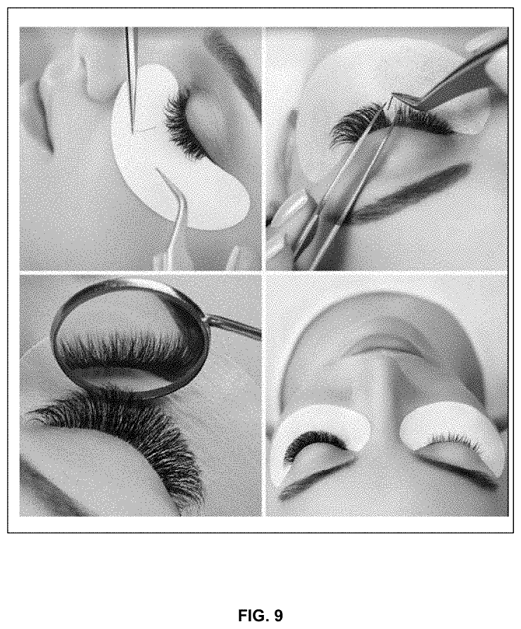

FIG. 8 illustrates the physical model arranged to provide training and assessment of cosmetics processes in accordance with the disclosure. The method avoids errors, injuries and liabilities to both the students and a training institute by providing the physical model for training and assessment and avoiding the need of a volunteer. In some embodiments, the method is used to provide training and assessment of esthetics and/or tattooing.

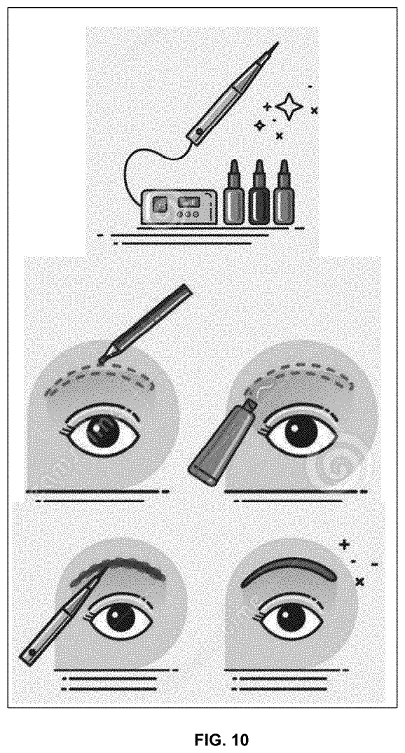

FIG. 9 illustrates the physical model arranged to provide training and assessment of eyelash extensions in accordance with the disclosure. Eyelash extensions are semi-permanent lashes that are hand-glued on top of natural lashes. The physical model enables the student to learn depth of eyelash and an amount of glue that may be applied without touching the human eyes. The server system 150 may track performance by measuring parameters like conditions, flow, pressure and positions of pressure from the student physical model 120B. In some embodiments, the method is used to provide training and assessment of permanent makeup. Permanent makeup, also known as micropigmentation, and cosmetic tattooing involves permanent pigmentation of the dermis and is achieved by inserting colored natural pigments into the dermal layer of the skin that produces articulate designs that resemble makeup. Tattoo machines are used to puncture the skin so the ink can deposit into the skin. The instruments used for the process are needles, blades, handles for microblading. The students may train on a plastic model early on, but they lack the texture and real-world features forcing the student to practice on volunteers to improve skill. The method uses the physical model with pressure sensors, VR glasses and a mechanical pen, so that the student is able to practice without any fear and at the same time they get the feedback of pain, wrong design or color. The student is able to change skin tone and color to create different shapes and sizes. The method avoids errors, injuries and liabilities to both the students and the training institute by providing a physical model for training and assessment and avoiding the need of a volunteer.

In some embodiments, the method is used to provide training and assessment of permanent lip make-up. The student may train on a plastic model early on, but it lacks the texture and real-world features, thereby forcing the student to practice on volunteers to improve skill. The method uses the physical model with pressure sensors, VR glasses and additional attachments like a mechanical pen and ink. The students are able to practice without any fear and at the same time they get the feedback of pain, wrong design or color. The students are able to change the skin tone and color to create different shapes and sizes. The system can also track performance by measuring parameters like conditions, flow, pressure and positions of pressure. The method avoids errors, injuries and liabilities to both the students and the training institute by providing a physical model for training and assessment and avoiding the need of a volunteer.

In some embodiments, the method is used to provide training and assessment of permanent eyeliner. This procedure enhances the shape and natural beauty of the eyes. The students may train on a plastic model early on, but they lack the texture and real-world features forcing the student to practice on volunteers to improve skill. The method uses the physical model with pressure sensors, VR glasses and a mechanical pen. The students are able to practice without any fear and at the same time get the feedback of pain, wrong design or color. The student is able to change skin tone and color to create different shapes and sizes. The server system may track performance by measuring parameters like conditions, flow, pressure and positions of pressure. Further, depth of the mechanical pen may be simulated in the mixed-reality environment.

FIG. 10 illustrates the physical model arranged to provide training and assessment of permanent eyebrows in accordance with the disclosure. A super fine pen is used to softly deposit pigment into the skin. It creates tiny hairlike strokes to make brows look thicker and appear more natural. Microblading is less invasive compared to the permanent tattoo since it is not deeply inserted into the skin. These procedures are commonly done to those who lost their hair due to old age or disease, such as alopecia totalis or chemotherapy. The method uses needles, blades, and handles for microblading. The student trains on a plastic model early on, but they lack the texture and real-world features forcing the student to practice on volunteers to improve skill. The physical model with pressure sensors, VR glasses and a mechanical pen enables the student to practice without any fear and at the same time get the feedback of pain, wrong design or color. The student is able to change skin tone and color to create different shapes and sizes. The server system 150 may track performance by measuring parameters like conditions, flow, pressure and positions of pressure. Further, the depth of the mechanical pen may be simulated in the mixed-reality environment. The method avoids errors, injuries and liabilities to both the students and the training institute by providing a physical model for training and assessment and avoiding the need of a volunteer.

In some embodiments, the method is used to provide training and assessment of microblading eyebrows. Microblading enhances the appearance of the eyebrows through a manual process of inserting pigment, which looks like tiny, hairlike strokes, into the upper layers of the skin. Microblading may also include scalp micropigmentation which is the art of creating the appearance on fuller thicker hair. The student may train on a plastic model early on, but they lack the texture and real-world features forcing the student to practice on volunteers to improve skill. With the help of the physical model with pressure sensors, VR glasses and a mechanical pen, the student is able to practice without any fear and at the same time get the feedback of pain, wrong design or color. The student is able to change their skin tone and color to create different shapes and sizes. The server system 150 may track performance by measuring parameters like conditions, flow, pressure and positions of pressure. Further, the depth of the mechanical pen may be simulated in a mixed reality environment. The students are able to change the skin tone and color to create different shapes and tones. The method avoids errors, injuries and liabilities to both the students and the training institute by providing a physical model for training and assessment and avoiding the need of a volunteer.

In some embodiments, the method is used to provide training and assessment of nursing. Nurses are medical assistants who aid medical practitioners in aspects ranging from supplying medication to aiding surgery. The method is used to teach students about the autonomy of the human body using the physical model. The physical model is further used to teach placement of nerves and tell-tale body signs to determine health of a patient by measuring interactions of the student with the student physical model by measuring parameters like conditions, flow, pressure and positions of pressure. The student system 120 may further display conditions and responses associated with the conditions using VR simulations in the student VR device.

In some embodiments, the method is used to provide training and assessment of respiratory therapy. Respiratory therapists assess the anatomy of patients and important landmarks via palpation (physical examination in medical diagnosis by pressure of the hand or fingers to the surface of the body specially to determine the condition). Respiratory therapy helps patients to breathe easier and subside their respiratory symptoms. The physical model is used to simulate palpation with the addition of the mixed reality environment to show analysis of the body of the patient and the treatment required for the patient.

In some embodiments, the method is used to provide training and assessment of dentistry. Dentists are a branch of doctors who specialize in assessment and treatment of dental health. Dentists analyze mouth conditions of the patient including teeth structure and gum health. The method uses the mixed reality environment, the physical model and artificial teeth as the physical part to provide training and assessment to the student. The method eliminates the need for human volunteers and reduce education costs for providing training and assessment of dentistry to the student.

In some embodiments, the method is used to provide training and assessment of kinesiology. Kinesiology is the science of studying dynamics of human movement and its anatomical, physiological and kinetic interaction with the body and environment. The method uses VR and the physical model to provide real-time feedback and interaction with the instructor.

In some embodiments, the method is used to provide training and assessment of micro needling. Micro needling: Derma pen's depth is dependent on fitzpatrick skin. Micro needling is a cosmetic procedure that involves pricking the skin with tiny sterilized needles. The small wounds cause the human body to make more collagen and elastin, which heal the skin and help look the human body younger. Micro needling may help with issues like acne, hair loss (also called alopecia), dark spots or patches on your skin (hyperpigmentation), large pores, reduced skin elasticity, scars, stretch marks, sun damage, fine lines and wrinkles. The students may train on a plastic model early on, but they lack the texture and real-world features forcing the student to practice on volunteers to improve skill. With the help of the physical model with pressure sensors, VR glasses and a mechanical pen, the student is able to practice without any fear and at the same time get the feedback of pain, wrong design or color. Students will be able to change their skin tone and color to create different shapes and sizes. The system can also track performance by measuring parameters like conditions, flow, pressure and positions of pressure. Further, the depth of the mechanical pen may be simulated in a mixed reality environment. The students will be able to change the skin tone and color to create different shapes and tones.

In some embodiments, the method is used to provide training and assessment of body tattooing. Body tattooing is a form of body art made by inserting ink, dyes, and/or pigments, either indelible or temporary, into the dermis layer of the skin to form a design. The art of making tattoos is known as tattooing. The student is only allowed to work on a plastic mannequin, that does not give real-time feedback and fails to provide the feel of human skin. With the help of the physical model with pressure sensors, VR glasses and a mechanical pen, the student is able to practice without any fear and at the same time get the feedback of pain, wrong design or color. The students are able to change their skin tone and color to create different shapes and sizes. The server system 150 may track performance by measuring parameters like conditions, flow, pressure and positions of pressure. Further, the depth of the mechanical pen may be simulated in a mixed reality environment. The student is able to change the skin tone and color to create different shapes and tones. With the help of VR students experience and practice numerous times or work on the model without the fear of making mistakes. The method avoids errors, injuries and liabilities to both the students and the training institute by providing a physical model for training and assessment and avoiding the need of a volunteer.

In some embodiments, the method is used to provide training and assessment of BB glow that is a customized foundation shade that is matched to the in tone. BB Glow is a painless semi-permanent pigmented serum that is applied with non-invasive nano derma needling. The student may train on a plastic model early on, but they lack the texture and real-world features forcing the student to practice on volunteers to improve skill. With the help of the physical model with pressure sensors, VR glasses and a mechanical pen, the student is able to practice without any fear and at the same time get the feedback of pain, wrong design or color. The students are able to change their skin tone and color to create different shapes and sizes. The server system 150 may track performance by measuring parameters like conditions, flow, pressure and positions of pressure. Further, the depth of the mechanical pen may be simulated in a mixed reality environment. The students are able to change the skin tone and color to create different shapes and tones. With the help of the student VR device 120A, the student experiences and practices numerous times or works on the physical model without the fear of making mistakes.

In some embodiments, the method is used to provide training and assessment of paramedical tattoo. This process involves paramedical scar camouflage tattooing which is the art of tattooing flesh tone pigments into the skin or scar to blend, minimize, and conceal discolorations. Paramedical tattoo may depend on scar types or working on scar tissue, tattoo techniques/advanced needle knowledge, pigments, consultation and contraindications, surgical/medical scars, burns/skin graft, areola, stretchmarks. The student is only allowed to practice on plastic mannequins without any feedback structure and shape. They have to use silicone fake skin to practice strokes that create an environmental burden once it is done it has to be thrown out. With the help of the physical model with pressure sensors, VR glasses and a mechanical pen, the student is able to practice without any fear and at the same time get the feedback of pain, wrong design or color. The student will be able to change their skin tone and color to create different shapes and sizes. The server system 150 may track performance by measuring parameters like conditions, flow, pressure and positions of pressure. Further, the depth of the mechanical pen may be simulated in a mixed reality environment. The student will be able to change the skin tone and color to create different shapes and tones. With the help of VR students can experience and practice numerous times or working on the model without the fear of making mistakes.

In some embodiments, the method is used to provide training and assessment of cupping massage. An ancient form of medicine known as cupping therapy. It is not like a regular massage, but does have the benefits of a deep-tissue massage where the therapist uses special cups on the body to create suction on the skin. The benefits of cupping therapy include reduced pain and inflammation, as well as better blood circulation, and a sense of relaxation and well-being. With the help of the physical model with pressure sensors and VR glasses, the student is able to practice without any fear and at the same time get the feedback of pain, wrong conduction or intensity. The server system 150 may also track performance by measuring parameters like conditions, flow, pressure and positions of pressure. Further, the depth of the mechanical pen may be simulated in a mixed reality environment. With the help of VR the student experiences and practices numerous times or works on the model without the fear of making mistakes. Furthermore, the mixed reality environment and the physical model may be used to visualize the effect on the body post treatment.

In some embodiments, the method is used to provide training and assessment of hot stone massages. A hot stone massage is a type of massage therapy. Hot stone massage requires the use of heated stones placed on the spine or stomach to alleviate pain and body scars. These rocks typically consist of basalt stone, Jade stone, Rollers stone, Gua Sha and Marble stone, a type of volcanic rock that retains heat. A therapist will massage the body while stones are placed on the patient's body. With the help of the physical model with pressure sensors and VR glasses, students will be able to practice without any fear and at the same time get the feedback of pain, wrong conduction or intensity. Hot stones can be simulated to be placed at different parts of the physical model and their impacts assessed. The server system 150 may track performance by measuring parameters like conditions, flow, pressure and positions of pressure. Further, the depth of the mechanical pen may be simulated in a mixed reality environment. With the help of VR students experience and practice numerous times or work on the physical model without the fear of making mistakes. Furthermore, XR and mannequin are used to visualize the effect on the body post treatment.

In some embodiments, the method is used to provide training and assessment of massage therapy. Massage therapy is the manipulation of the soft tissues of the body. Massage therapy is commonly given with hands, fingers, elbows, knees, forearms, feet, or a device. The purpose of massage therapy is generally for the treatment of body stress or pain. Optionally, a mix of VR, mixed reality and the physical model will be required. During training, the use of superficial and deep pressure is required to be applied. The physical model will register these pressures using a 3D type pressure sensing plate located in the shoulder, neck, spine and hip region.

In some embodiments, the method provides training and assessment of healthcare aid. Healthcare aid professionals help patients with personal hygiene, dressing, bathing, and other daily tasks. They also work with a nurse, personal care aide, a CNA, nurse aide, nursing assistant, and other caregivers and in-home care professionals and perform basic health care services for patients including checking vital signs or administering prescription medication. The method provides the student the option of conducting their training session in virtual reality without having to visit facilities there by providing faster course completion, fulfill demands and cheaper fees. The physical model captures information on the student's conduction in various aspects like spatial, intensity repeatability, condition simulation etc. Moreover, the student may attend the course at their own pace and get access to the latest curriculum since the complete system may be linked to a central certifying agency.

In some embodiments, the method is used to provide training and assessment of midwifery. During the studies of labor, or childbirth, in training, students cannot understand how much pressure a body can bear and how each stage of childbirth happens. With the physical model, each stage of childbirth may be mechanically reproduced and the exact pressure and contractions, rhythm of contraction helps the student to learn remotely. This requires a mechanical physical model with additional attachments to the physical model with VR glasses help to understand the whole childbirth process. With the help of the physical model with pressure sensors and VR glasses, the student will be able to understand and visualize stages of childbirth and can help students to understand the complete process of childbirth and attending to the patient. Physical model with pressure sensors, VR glasses and a condition simulator for mimicking particular condition is required.

| Condition | Simulation Props |
|---|---|
| Tumor | Marbles under synthetic skin |
| Trigger Points | Tight Band Like feel in muscle with sensitive |
| | points |
| Adhesion | small marble like hard thick feeling on muscle, |
| | like tissue is stuck together which is less mobile. |
| muscular | week, soft and little resilience comparatively |
| atrophy | small muscle |
| swelling | Baggy and congested area |
| limited ROM | muscle spasm, heard and feel firmer for joint |
| | capsules bone to bone-like hitting brick |
| Restricted | tissue stretch, empty |
| ROM | |
| tender point | localized sensitive points |
| referred pain | sensitive point with referring pain in distance |
| | area |
| crepitus | palpable roughness in the joint or tendon that is |
| | noted with movement and sometimes it is |
| | accompanied by audible crunching. |
| In Jow | Hypertonicity, trigger points and tenderness due |
| | to ischemia may be palpated in a variety of |
| | muscles. The muscles of mastication are affected |
| | by jaw clenching. Apical breathing contributes to |
| | hypertonicity and TPs in the neck and shoulder |
| | muscles. Low back muscles may be tight from |
| | holding the body rigidly, popping or clicking, |
| | jow deviation |
| Strain | thick, fibrous, possible adhesions and or palpable |
| | gap (tissue progressively less firm |
| Cruciate Injury- | Texture: adhesions in quads, gastrocs, |
| Cruciate: | hamstrings, boggy edema around the knee. |
| Meniscal | adhesions in quads, gastrocs, hamstrings, boggy |
| Injury | edema around knee |
| Whiplash | firm edema (acute), adhesions (sub-acute/chronic) |
| Plantar | thickening, adhesions tender to touch, (anterior/ |
| Fasciitis | medial aspect affected plantar fascia) |
| Tendinitis | swelling at tendon (acute), adhesions granular |
| | (chronic) |
| Frozen | fibrosing/disuse atrophy in rotator cuff muscles |
| Shoulder | (sub-acute) |
| Torticollis | Text: ropy (upper/middle traps) scalenes, SCM, |
| | lev scap, rhomboids (bilateral) |
| Pes Planus | thickness talus |
| Iliotibial Band | ITB (affected side) thickened, w possible |
| Contracture | adhesions |
| (ITB | |
| contracture) | |
| Hyperlordosis | thickened/reinforced ITB and lumbar fascia |
| Scoliosis | fibrosing on the concave side. |
| Hyperkyphosis | thickened pectoral fascia |
| TMJD | edema, fibrosing/adhesions (MOM). |
| Carpal Tunnel | boggy edema at carpal tunnel w/ adhesions at |
| Syndrome | flexor retinaculum, atrophy at thenar (in later |
| | stages) |

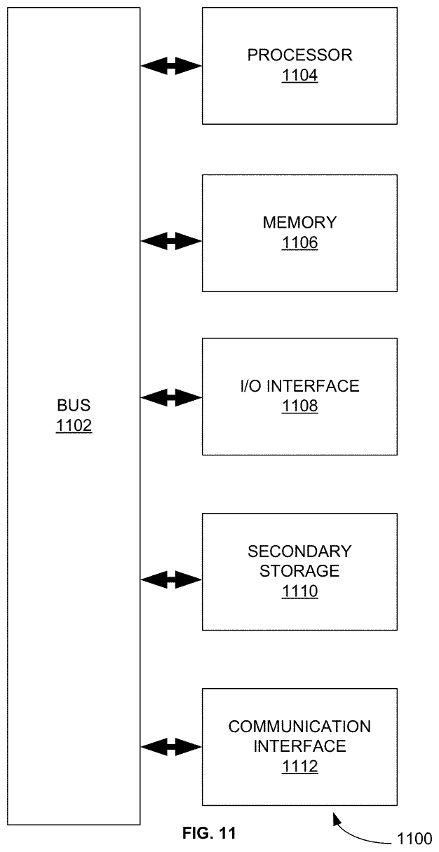

FIG. 11 is an illustration of an exemplary computing arrangement 1100 in which the various architectures and functionalities of the various previous implementations may be implemented. As shown, the computing arrangement 1100 includes at least one processor 1104 that is connected to a bus 1102, wherein the computing arrangement 1100 may be implemented using any suitable protocol, such as PCI (Peripheral Component Interconnect), PCI-Express, AGP (Accelerated Graphics Port), HyperTransport, or any other bus or point-to-point communication protocol (s). The computing arrangement 1100 also includes a memory 1106.

Control logic (software) and data are stored in the memory 1106 which may take the form of random-access memory (RAM). In the present description, a single semiconductor platform may refer to a sole unitary semiconductor-based integrated circuit or chip. It should be noted that the term single semiconductor platform may also refer to multi-chip modules with increased connectivity which simulate on-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The computing arrangement 1100 may also include a secondary storage 1110. The secondary storage 1110 includes, for example, a hard disk drive and a removable storage drive, representing a floppy disk drive, a magnetic tape drive, a compact disk drive, digital versatile disk (DVD) drive, recording device, universal serial bus (USB) flash memory. The removable storage drive at least one of reads from and writes to a removable storage unit in a well-known manner.

Computer programs, or computer control logic algorithms, may be stored in at least one of the memory 1106 and the secondary storage 1110. Such computer programs, when executed, enable the computing arrangement 1100 to perform various functions as described in the foregoing. The memory 1106, the secondary storage 1110, and any other storage are possible examples of computer-readable media.

In an implementation, the architectures and functionalities depicted in the various previous figures may be implemented in the context of the processor 1104, a graphics processor coupled to a communication interface 1112, an integrated circuit (not shown) that is capable of at least a portion of the capabilities of both the processor 1104 and a graphics processor, a chipset (i.e., a group of integrated circuits designed to work and sold as a unit for performing related functions, etc.).

Furthermore, the architectures and functionalities depicted in the various previous figures may be implemented in the context of a general computer system, a circuit board system, a game console system dedicated for entertainment purposes, an application-specific system. For example, the computing arrangement 1100 may take the form of a desktop computer, a laptop computer, a server, a workstation, a game console, an embedded system.

Furthermore, the computing arrangement 1100 may take the form of various other devices including, but not limited to a personal digital assistant (PDA) device, a mobile phone device, a smart phone, a television, etc. Additionally, although not shown, the computing arrangement 1100 may be coupled to a network (e.g., a telecommunications network, a local area network (LAN), a wireless network, a wide area network (WAN) such as the Internet, a peer-to-peer network, a cable network, or the like) for communication purposes through an I/O interface 1108.

It should be understood that the arrangement of components illustrated in the figures described are exemplary and that other arrangement may be possible. It should also be understood that the various system components (and means) defined by the claims, described below, and illustrated in the various block diagrams represent components in some systems configured according to the subject matter disclosed herein. For example, one or more of these system components (and means) may be realized, in whole or in part, by at least some of the components illustrated in the arrangements illustrated in the described figures.

In addition, while at least one of these components are implemented at least partially as an electronic hardware component, and therefore constitutes a machine, the other components may be implemented in software that when included in an execution environment constitutes a machine, hardware, or a combination of software and hardware.

Although the disclosure and its advantages have been described in detail, it should be understood that various changes, substitutions, and alterations can be made herein without departing from the scope and spirit of the disclosure.

What is claimed is:

1. A method for providing training and assessment of physiatrics based therapy, wherein the method comprising the steps of:
performing a specific procedure corresponding to the physiatrics based therapy on an instructor physical model;
communicating a first digital data representing the specific procedure performed on the instructor physical model to an instructor computing device, wherein the first digital data represents activation points on the instructor physical model;
communicating the first digital data from the instructor computing device to an instructor unit comprising the instructor physical model and an instructor virtual reality (VR) device to overlay the first digital data on the instructor physical model using the instructor VR device;
communicating the specific procedure from the instructor computing device as instructions through a server to a student computing device;
performing the specific procedure on a student physical model as per the instructions;
communicating a second digital data representing the specific procedure performed on the student physical model to the student computing device, wherein the second digital data represents the activation points on the student physical model;
communicating the second digital data from the student computing device to a student unit comprising the student physical model and a student VR device to overlay the second digital data on the student physical model using the student VR device;
communicating the second digital data from the student computing device through the server to the instructor computing device; and
comparing the second digital data with the first digital data for the specific procedure corresponding to the physiatrics based therapy for providing training and assessment of physiatrics based therapy.

2. The method as claimed in claim 1, wherein the method comprises of configuring the instructor computing device to obtain a spatial map of pressure applied at different locations on the instructor physical model, at different points over time corresponding to the activation points on performing the specific procedure, wherein the spatial map is obtained using the first digital data that includes a total amount of pressure applied to a section of the instructor physical model and a depth at which the pressure is applied.

3. The method as claimed in claim 1, wherein the method comprises of configuring the instructor computing device to combine the first digital data with an associated virtual environment data to render the combined data on a 3D model of a human body to virtually present the activation points associated with the specific procedure.

4. The method as claimed in claim 1, wherein the method comprises of configuring the student computing device to obtain a spatial map of pressure applied at different locations on the student physical model at different points over time corresponding to the activation points on performing the specific procedure, wherein the spatial map is obtained using the second digital data that includes a total amount of pressure applied to a section of the student physical model and a depth at which the pressure is applied.

5. The method as claimed in claim 1, wherein the method comprises configuring the student computing device to combine the second digital data with the associated virtual environment data to render the combined data on the 3D model of the human body to virtually present the activation points associated with the specific procedure.

6. The method as claimed in claim 1, wherein the method comprises of configuring the student computing device to capture a temporal sequence associated with the specific procedure and to determine performance values of each of the time-based steps for the student performing the specific procedure.

7. The method as claimed in claim 1, wherein the physical model comprises a physical mannequin installed with the physical model of an anatomical structure of the human body.

8. The method as claimed in claim 1, wherein the method comprises of overlaying, using the student VR device, corrective feedback in conducting the specific procedure on the student physical model, wherein the corrective feedback is received from the instructor computing device.

9. The method as claimed in claim 1, wherein the first digital data and the second digital data comprises an application programming interface (API) data that comprises a student identifier, a timestamp, a procedure identifier, an instructor identifier, a geography identifier for headers, streams of location identifiers, depth and a data stream comprising a quantum of pressure values.

10. The method as claimed in claim 1, wherein the physical model mimics conditions of the human body for training the student in the physical model for feeling the conditions and for providing virtual feedback.

11. The method as claimed in claim 1, wherein the method comprises of providing a virtual environment for multiple students and instructors to simulate a classroom environment, or a hospital environment.

12. A system for providing training and assessment of physiatrics based therapy, wherein the system comprising:
an instructor physical model, wherein a specific procedure corresponding to the physiatrics based therapy is performed on the instructor physical model;
an instructor computing device configured to receive a first digital data representing the specific procedure performed on the instructor physical model, wherein the first digital data represents activation points on the instructor physical model;
an instructor unit configured to receive the first digital data from the instructor computing device, wherein the instructor unit comprises the instructor physical model and an instructor virtual reality (VR) device, wherein the instructor computing device is communicatively connected to the instructor unit;
a student computing device configured to receive the specific procedure from the instructor computing device as instructions, wherein the student computing device is communicatively connected to the instructor computing device;
a student physical model, wherein the specific procedure is performed on the student physical model as per the instructions, wherein the student computing device is configured to receive a second digital data representing the specific procedure performed on the student physical model, wherein the second digital data represents the activation points on the student physical model;
a student unit comprising the student physical model and a student VR device, wherein the student unit receives the second digital data from the student computing device, wherein the student computing device is communicatively connected to the student unit, wherein the student computing device communicates the second digital data to the instructor computing device; and
a server that is configured to (i) overlay the first digital data on the instructor physical model using the instructor VR device, (ii) overlay the second digital data on the student physical model using the student VR device, and (iii) compare the second digital data with the first digital data for the specific procedure corresponding to the physiatrics based therapy for providing training and assessment of physiatrics based therapy.

13. The system as claimed in claim 12, wherein the server performs operations comprising updating, deleting, adding, retrieving data representing instructions on receiving a corresponding request from the instructor computing device.

14. The system as claimed in claim 12, wherein the instructor computing device is configured to obtain a spatial map of pressure applied at different locations on the instructor physical model, at different points over time corresponding to the activation points on performing the specific procedure, wherein the spatial map is obtained using the first digital data that includes a total amount of pressure applied to a section of the instructor physical model and a depth at which the pressure is applied.

15. The system as claimed in claim 12, wherein the instructor computing device is configured to combine the first digital data with an associated virtual environment data to render the combined data on a 3D model of a human body to virtually present the activation points associated with the specific procedure.

16. The system as claimed in claim 12, wherein the student computing device is configured to obtain a spatial map of pressure applied at different locations on the student physical model at different points over time corresponding to the activation points on performing the specific procedure, wherein the spatial map is obtained using the second digital data that includes a total amount of pressure applied to a section of the student physical model and a depth at which the pressure is applied.

17. The system as claimed in claim 12, wherein the student computing device is configured to combine the second digital data with the associated virtual environment data to render the combined data on the 3D model of the human body to virtually present the activation points associated with the specific procedure.

18. A non-transitory computer-readable storage medium storing a sequence of instructions, which when executed by a processor, causes training and assessment of physiatrics based therapy, the sequence of instructions comprising:
performing a specific procedure corresponding to the physiatrics based therapy on an instructor physical model;
communicating a first digital data representing the specific procedure performed on the instructor physical model to an instructor computing device, wherein the first digital data represents activation points on the instructor physical model;
communicating the first digital data from the instructor computing device to an instructor unit comprising the instructor physical model and an instructor virtual reality (VR) device to overlay the first digital data on the instructor physical model using the instructor VR device;
communicating the specific procedure from the instructor computing device as instructions through a server to a student computing device;
performing the specific procedure on a student physical model as per the instructions; communicating a second digital data representing the specific procedure performed on the student physical model to the student computing device, wherein the second digital data represents the activation points on the student physical model;
communicating the second digital data from the student computing device to a student unit comprising the student physical model and a student VR device to overlay the second digital data on the student physical model using the student VR device;
communicating the second digital data from the student computing device through the server to the instructor computing device; and
comparing the second digital data with the first digital data for the specific procedure corresponding to the physiatrics based therapy for providing training and assessment of physiatrics based therapy.
